(19) United States
(12) Patent Application Publication
(10) Pub. No.: US 2004/0004971 A1
(43) Pub. Date: Jan. 8, 2004

(54) Method and implementation for multilevel queuing

(76) Inventor: LingHsiao Wang, Irvine, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/189,750

(22) Filed: Jul. 3, 2002

(51) Int. Cl. H04L 12/56; H04L 12/26

(52) U.S. Cl. 370/412; 370/252; 370/230.1; 370/235; 370/395.4

(57) ABSTRACT

A method and implementation are disclosed of partitioning data traffic over a network. The invention includes providing a network having a plurality of priority queues for forwarding data packets where a predetermined number of credits are assigned to each priority queue. Data packets are passed to respective ones of a plurality of priority queues. If at least one of the predetermined number of credits is available, the credit is associated with a respective data packet and the packet is forwarded to a flow queue associated with the respective priority queue. If at least one of the predetermined number of credits is not available, the data packet waits until a credit is returned. When a packet is transmitted, its respectively associated credit is returned to the queue in which it originated for associating with another respective waiting data packet.

### BACKGROUND OF THE INVENTION

The present invention is directed to the field of packet queuing, particularly multilevel packet queuing of the type used in different transportation media, e.g. ATM, Ethernet, T1/E1. Such multilevel queuing is very complex. In a typical enterprise implementation, a customer sets up a data network by leasing T1/E1 circuits or subscribing bandwidth from a switched Asynchronous Transfer Mode (ATM) network that provides similar service as T1/E1 circuits.

Within such network connections, a user has the responsibility to prioritize traffic usage. When network service transitions from a “network access provider” to a “network service provider,” and the connections shift to a packet-switching network, the responsibilities for prioritizing traffic moves to network operators. In a network service provider environment, it is desirable to have the capability to partition the bandwidth and prioritize traffic even within one data flow as subscribed by customer.

One previous-type solution was contemplated in U.S. Pat. No. 6,163,542 to Carr et al. which seeks to shape the traffic in an ATM network at level of a VPC (Virtual Path Connection) and arbitrate the bandwidth between component VCCs (Virtual Channel Connections). However, the system of Carr et al. is limited in that the idea is only applicable for ATM networks and the shaping unit, VPC, is too big for management by a network operator. Furthermore, the arbitration between components is not flexible enough for other types of dynamic networks.

### SUMMARY OF THE INVENTION

A method and implementation are disclosed of partitioning data traffic over a network. The invention includes providing a network having a plurality of priority queues for forwarding data packets where a predetermined number of credits are assigned to each priority queue. Data packets are passed to respective ones of a plurality of priority queues. If at least one of the predetermined number of credits is available, the credit is associated with a respective data packet and the packet is forwarded to a flow queue associated with the respective priority queue. If at least one of the predetermined number of credits is not available, the data packet waits until a credit is returned. When a packet is transmitted, its respectively associated credit is returned to the queue in which it originated for associating with another respective waiting data packet.

As will be realized, the invention is capable of other and different embodiments and its several details are capable of modifications in various respects, all without departing from the invention. Accordingly, the drawing and description are to be regarded as illustrative and not restrictive.

### BRIEF DESCRIPTION OF THE DRAWINGS

FIG. 1 shows a multilevel queuing structure in accordance with the present invention.

FIGS. 2A and 2B show exemplary data structures in accordance with the present invention.

### DETAILED DESCRIPTION OF THE INVENTION

The present invention provides a method to partition and prioritize the traffic of a customer's flow over different transportation media, e.g. ATM, Ethernet, T1/E1. The invention enables dynamic assignment from queues to flows in a manner that can be realized for “real world” network operation.

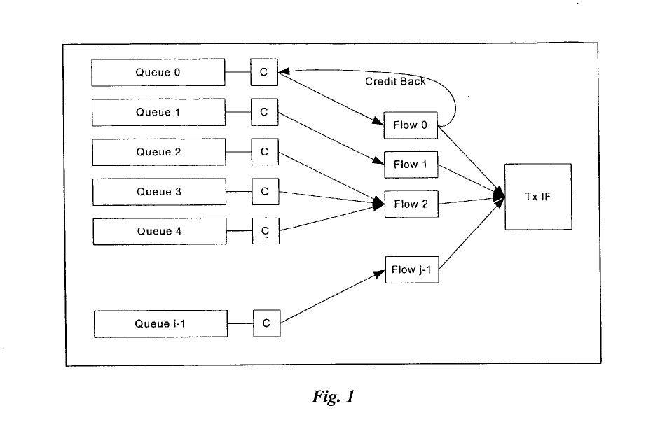

In accordance with the invention, a data packet is received, and is classified according to the respective flow and the respective priority to which it belongs. This information is presented to network as a “queue number.” The packet will be passed to and stored in the respective priority queue waiting to be scheduled. For example, in the system shown in FIG. 1, a packet having priority 1 in flow 2 will be sent to the queue 3. For bandwidth management within a flow that may be regulated by another layer of bandwidth partition policies, a certain number of “credits” are assigned to each queue. Queues having higher priority will have a greater number of credits assigned thereto. The number of credits for each queue will represent a fraction of the total number of credits assigned to all queues such that:

$${Share}_{i} = {credit}_{i} / {\sum }_{j ∈ F} {credit}_{j} ;$$

where

F={priority queues that belongs to flown f}

Shareᵢ=fraction of overall flow bandwidth can be used by priority queue i.

In this way, each queue is given a respective portion of the total bandwidth available to the network. In operation, when the packet goes to a respective queue, it will trigger an event that checks the “credit availability” for that queue. If a credit is available, the packet at the “head of line” will then be forwarded to the flow queue associated to the queue. If there is no credit available, the packet has to wait until a credit is returned. When a packet had been passed to the next step processor from the flow queue, the credit will be returned to the queue in which it originated. The returning of the credit will also trigger a “credit check” that moves a packet to the flow queue if the priority queue is not empty, so that the next packet “in line” uses that credit to be forwarded into the flow. These two events together are completed to move all packets from their priority queues into the flow queue.

Credit Scheme #1

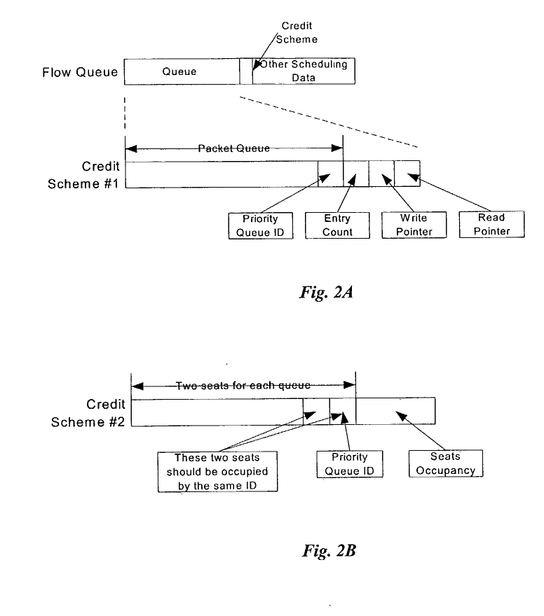

In a first credit scheme in accordance with the present invention, as shown in FIG. 2A, the flow queue simply queues all the packets from different priority queues and serves them to the network in a “first in first out” manner. The fields depicted in FIG. 2A are indicated as follows: “Other scheduling data” is information that may be needed for flow layer traffic management that is not part of the invention. “Credit Scheme” is to identify the priority queue scheduling in credit base of strict priority. “Read pointer,” “write pointer,” “entry count” fields are for the purpose of managing the packet FIFO queue followed. “Priority Queue ID” is for queued entry where the actual packet descriptor is still sitting in the priority queue. The Queue ID enables the scheduler to get the packet information from the priority queue and return the credit back to the priority queue.

In accordance with this embodiment, the credit base scheduling can be performed so as to further partition the available bandwidth available for a respective flow into different priorities. For example, a particular flow can be partitioned to contain four priorities that have been assigned credit 1, 3, 5, 7 respectively. The flow queue should always contain at least one packet for each respective credits 1, 3, 5, 7 from priority 0, 1, 2, 3 respectively if every priority queue is not empty. In this way, the bandwidth for that flow will be partitioned into fractional portions 1/16, 3/16, 5/16 and 7/16 such that the fractions add up to 100% of the total available bandwidth to that particular flow. This implementation is simpler and more flexible in terms of priority combination then previous-type implementations, such as “weighted round-robin” and other such schemes. However, in this embodiment, there can be potentially high transmission latency due to the waiting time in the flow queue irrespective the quantity of credit assigned to each queue.

Credit Scheme #2

In a second credit scheme in accordance with the present invention, as shown in FIG. 2B, there is one seat reserved for each priority in the flow queue. The flow queue, not an actual first-in-first-out “queue” in this scheme, serves the packets by strict priority to guarantee the shortest latency on higher priority traffic. The fields depicted in FIG. 2B are indicated as follows (where the fields do not include flow queue control information). “Seats occupancy” indicates one bit for each seat, and will be turn on if occupied. The scheduler simply finds the first one active and starts the service on that one. The occupancy bit shall be deactivated after the entry been served and passed to the next stage processing. The “Priority Queue ID” is the same as credit scheme #1 If the there are multiple seats for a single priority queue, they simply represent the priority queue has at least that many packets waiting. Since the entry does not represent any packet, they can be served not in sequence as they been activated. The front seats (i.e. high priority packets) will get served first and then the back seats (i.e. low priority packets). The credit assigned to each priority queue is equal to the number of seats for that queue. The number of seats available to a priority queue will not affect the bandwidth or the priority it will be served. It simply compensates the pipelined credit processing latency between flow queues and priority queues. This scheme can not partition the bandwidth between all priority queues but can address lower latency for higher priority queues. For flows that aggregate a real time stream and regular data, this scheme will work better. The size of flow queue data structure will limit the number of credits (or seats) available and therefore limit the number of queues that can be associated for both credit schemes.

As described hereinabove, the present invention enhances the detail controllability that is lacked in previous type methods and implementations. However, it will be appreciated that various changes in the details, materials and arrangements of parts which have been herein described and illustrated in order to explain the nature of the invention may be made by those skilled in the area within the principle and scope of the invention will be expressed in the appended claims.

I claim:

1. A method of partitioning data traffic over a network comprising:
providing a network having a plurality of priority queues for forwarding data packets;
assigning a predetermined number of credits to each priority queue;
passing a data packet to a respective one of a plurality of priority queues;
wherein, if at least one of the predetermined number of credits is available, associating the credit with the data packet and forwarding the data packet to a flow queue associated with the respective priority queue;
wherein if at least one of the predetermined number of credits is not available, the data packet waits until a credit is returned, and
wherein when a packet is transmitted, returning its respectively associated credit to the queue in which it originated for associating with another respective waiting data packet.

2. The method of claim 1 further comprising the step of assigning a queue number including classifying the data packet according to a respective flow and a respective priority to which it belongs.

3. The method of claim 1 wherein the step of returning the credit comprises a step of triggering a credit check that moves the waiting data packet into the flow queue, wherein the waiting data packet uses the returned credit to be forwarded into the flow queue.

4. The method of claim 1 wherein the predetermined number of credits for each respective priority queue is such that a respective higher priority queue will have more credits than a respective lower priority queue.

5. The method of claim 1 wherein the number of credits for each queue will represent a fraction of the total number of credits assigned to all queues, such that each queue is given a respective portion of the total bandwidth available to the network.

6. The method of claim 5 wherein the credits are assigned so as to partition the available bandwidth available for a respective flow into different priorities.

7. The method of claim 6 wherein the bandwidth is partitioned into fractional portions such that the fractions add up to 100% of the total available bandwidth.

8. The method of claim 5 wherein each priority queue in the flow queue has a respective seat such that packets with high priority seats get served before packets with low priority seats, wherein the predetermined number of credits assigned to each priority queue are equal to the number of seats for that queue.

9. An implementation for partitioning data traffic over a network comprising:
means for providing a network having a plurality of priority queues for forwarding data packets;
means for assigning a predetermined number of credits to each priority queue;
means for passing a data packet to a respective one of a plurality of priority queues;
means for determining if at least one of the predetermined number of credits is available, means are further comprised for associating the credit with the data packet and forwarding the data packet to a flow queue associated with the respective priority queue;
wherein if the means for determining determines that at least one of the predetermined number of credits is not available, means are further comprised for causing the data packet to wait until a credit is returned, and
wherein when a packet is transmitted, means are further comprised for returning its respectively associated credit to the queue in which it originated for associating with another respective waiting data packet.

10. The implementation of claim 9 further comprising means for assigning a queue number including classifying the data packet according to a respective flow and a respective priority to which it belongs.

11. The implementation of claim 9 wherein the means for returning the credit comprises means for triggering a credit check that moves the waiting data packet into the flow queue, wherein the waiting data packet uses the returned credit to be forwarded into the flow queue.

12. The implementation of claim 9 wherein the predetermined number of credits for each respective priority queue is such that a respective higher priority queue will have more credits than a respective lower priority queue.

13. The implementation of claim 9 wherein the number of credits for each queue will represent a fraction of the total number of credits assigned to all queues, such that each queue is given a respective portion of the total bandwidth available to the network.

14. The implementation of claim 13 wherein the credits are assigned so as to partition the available bandwidth available for a respective flow into different priorities.

15. The implementation of claim 14 wherein the bandwidth is partitioned into fractional portions such that the fractions add up to 100% of the total available bandwidth.

16. The implementation of claim 13 wherein each priority queue in the flow queue has a respective seat such that packets with high priority seats get served before packets with low priority seats, wherein the predetermined number of credits assigned to each priority queue are equal to the number of seats for that queue.
